SEQUENCE LISTING (1 sequence)

SEQ ID NO: 1 - DNA, 511 bp, E-coli bacteria
aatatggtattccgcaaatctccactggcgatatgctgcgtgctgcggtcaaatctggctccgagctgggtaaacaagcaaaagacattatggatgctggcaaactggtcaccgacgaactggtgatcgcgctaaagagcgcattgctcaggaagactgccgctacggtttcctgttggacggcttcccgcgtaccattccgcaggcagacgcgatgaaagaagcgggcatcaatgttgattacgttctggaattcgacgtaccggacgaactgattgttgaccgtatcgtaggccgccgcgttcacgcgccgtctggtcgtgtttatcacgttaaattcaatccgccgaaagtagaaggcaaagacgacgttaccggtgaagagctgactacccgtaaagacgatcaggaagagaccgtacgtaaacgtctggttgaataccatcagatgactgcaccgctgatcggctactactccaaagaagcggaagcgggtaacaccaaatacgcg

(19) United States
(12) Patent Application Publication
(10) Pub. No.: US 2010/0069253 A1
(43) Pub. Date: Mar. 18, 2010

(54) Impedance Spectroscopy Measurement of DNA

(76) Inventor: Andrei L. Gindilis, Vancouver, WA (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(21) Appl. No.: 12/210,062

(22) Filed: Sep. 12, 2008

(51) Int. Cl. C40B 30/04; C40B 40/08

(52) U.S. Cl. 506/9; 506/17

(57) ABSTRACT

An impedance spectroscopy system and method are provided for quantitatively measuring DNA. The method provides a transducer having electrode surfaces exposed to a shared local environment. The electrode surfaces are functionalized with an oligonucleotide to interact with a predetermined DNA target. A DNA sample solution is introduced into the local environment. The solution includes nucleotides, polymerase enzyme, and primers. The DNA sample is thermocycled to promote a first DNA target polymerase chain reaction (PCR). Then, capacitance is measured between a pair of transducer electrodes, and in response to measuring the capacitance, a determination is made of the presence of first DNA amplicons in the DNA sample. Typically, a number of thermocycles are performed and capacitance measurements are made after each cycle, so that an amplicon growth rate can be determined.

### BACKGROUND OF THE INVENTION

1. Field of the Invention

This invention generally relates to Deoxyribonucleic acid (DNA) detection and, more particularly, to a system and method for the measurement of DNA by impedance spectroscopy.

2. Description of the Related Art

Microarray technology is a power research tool that permits the assaying of multiple analytes in a single sample—a multiplexed assay format. To perform such assay, a microarray has to contain multiple transducers modified with different bio-components. Selective attachment of a desired bio-component to a particular transducer constitutes one of the biggest challenges in the microarray technology. At present, the major approaches for microarray multiplexing are; (i) spotting of different bio-components over an array; (ii) physical separation of transducers via a nano-fluidic set of connections, and target delivery of bio-components to pre-selected transducers; (iii) self-assembling of tagged bio-components on an array surface that is modified with an agent capable of the specific capturing of bio-component tags; and (iv) controlled synthesis of bio-components on the surface of transducers.

Real time polymerase chain reaction (PCR) techniques are widely used for monitoring of biomarker gene expression, genotyping, detection of mutations, and rapid diagnosis and quantitation of infections in clinical microbiology. It can also be used in methylation detection, DNA damage and radiation exposure measurements and high-resolution genotyping that would have been less efficient or impossible to perform with the standard PCR.

PCR derives its name from one of its key components, a DNA polymerase used to amplify a piece of DNA by in vitro enzymatic replication. As PCR progresses, the DNA thus generated is itself used as a template for replication. This sets in motion a chain reaction in which the DNA template is exponentially amplified. With PCR it is possible to amplify a single or few copies of a piece of DNA across several orders of magnitude, generating millions or more copies of the DNA piece. PCR can be extensively modified to perform a wide array of genetic manipulations.

Almost all PCR applications employ a heat-stable DNA polymerase, such as Taq polymerase, an enzyme originally isolated from the bacterium Thermoiiis aqtuatlcits. This DNA polymerase enzymatically assembles a new DNA strand from DNA building blocks, the nucleotides, using single-stranded DNA as template and DNA oligonucleotides (also called DNA primers) required for initiation of DNA synthesis. The vast majority of PCR methods use thermal cycling, i.e. alternately heating and cooling the PCR sample to a defined series of temperature steps. These thermal cycling steps are necessary to physically separate the strands (at high temperatures) in a DNA double helix (DNA melting) used as template during DNA synthesis (at lower temperatures) by the DNA polymerase to selectively amplify the target DNA. The selectivity of PCR results from the use of primers that are complementary to the DNA region targeted for amplification under specific thermal cycling conditions.

A basic PCR set up requires several components and reagents. These components include:

DNA template that contains the DNA region (target) to be amplified.

Two primers which are complementary to the DNA regions at the 3′ (three prime) end of each DNA strand.

A DNA polymerase such as Taq polymerase or another DNA polymerase with a temperature optimum at around 70° C.

Deoxynucleoside triphosphates (dNTPs; also very commonly and erroneously called deoxynucleotide triphosphates), the building blocks from which the DNA polymerases synthesizes a new DNA strand.

Buffer solution, providing a suitable chemical environment for optimum activity and stability of the DNA polymerase.

Divalent cations, magnesium or manganese ions; generally Mg²⁺ is used, but Mn²⁺ can be utilized for PCR-mediated DNA mutagenesis, as higher Mn²⁺ concentration increases the error rate during DNA synthesis.

Monovalent cation potassium ions.

FIG. 1 is a schematic diagram depicting a PCR cycle (prior art). In stage one (1) denaturing occurs, e.g., at 94-96° C. for 20-30 seconds, melting the DNA template and primers by disrupting the hydrogen bonds between complementary bases of the DNA strands, yielding single strands of DNA. In stage two (2) annealing occurs, e.g., at ˜65° C. for 20-40 seconds, which permits the allowing annealing of the primers to the single-stranded DNA template. Typically, the annealing temperature is about 3-5 degrees Celsius below the Tm of the primers used. Stable DNA-DNA hydrogen bonds are only formed when the primer sequence very closely matches the template sequence. The polymerase binds to the primer-template hybrid and begins DNA synthesis.

In stage three (3) extension or elongation occurs, e.g., at 72° C. At this step the DNA polymerase synthesizes a new DNA strand complementary to the DNA template strand by adding dNTPs that are complementary to the template in 5′ to 3′ direction, condensing the 5′-phosphate group of the dNTPs with the 3′-hydroxyl group at the end of the nascent (extending) DNA strand. The extension time depends both on the DNA polymerase used and on the length of the DNA fragment to be amplified. As a rule-of-thumb, at its optimum temperature, the DNA polymerase will polymerize a thousand bases per minute. Under optimum conditions, i.e. if there are no limitations due to limiting substrates or reagents, at each extension step, the amount of DNA target is doubled, leading to exponential (geometric) amplification of the specific DNA fragment.

Two cycles are shown. The solid lines represent the DNA template to which primers anneal that are extended by the DNA polymerase (circles), to give shorter DNA products (hatched lines), which themselves are used as templates as PCR progresses. The PCR usually consists of a series of 20 to 40 repeated temperature changes called cycles; each cycle typically consists of 2-3 discrete temperature steps. Most commonly, PCR is carried out with cycles that have three temperature steps. The cycling is often preceded by a single temperature step (called hold) at a high temperature (>90° C.), and followed by one hold at the end for final product extension or brief storage. The temperatures used and the length of time they are applied in each cycle depend on a variety of parameters. These include the enzyme used for DNA synthesis, the concentration of divalent ions and dNTPs in the reaction, and the melting temperature (Tm) of the primers.

Quantitative PCR (Q-PCR) is used to measure the quantity of a PCR product (preferably real-time). It is the conventional method used to quantitatively measure the starting amounts of DNA, cDNA or RNA. Q-PCR is commonly used to determine whether a DNA sequence is present in a sample and the number of its copies in the sample. The conventional method with the highest level of accuracy is Quantitative real-time PCR. It is often confusingly known as RT-PCR (Real Time PCR) or RQ-PCR. QRT-PCR or RTQ-PCR is a more appropriate contraction. RT-PCR commonly refers to reverse transcription PCR, which is often used in conjunction with Q-PCR. QRT-PCR methods use fluorescent dyes, such as Sybr Green, or fluorophore-containing DNA probes, such as TaqMan, to measure the amount of amplified product in real time.

Detection is based on differences in the fluorescence of dyes bound to single-strand versus double-strand DNA molecules. The optically detectable dyes act as a label. The practical application of fluorescence detecting techniques are limited by (i) the high initial expenditure of purchasing a PCR unit integrated with a fluorescent reader; (ii) the high ownership costs due to expensive consumables (fluorescent dyes and special kits); and, (iii) expensive maintenance of optical light-detecting equipment. In addition, miniaturization of the fluorescent based real time PCR, if possible, is very challenging.

Other detection methods add Ferrocene based labels, an organometallic compound Fe(C₅H₅)₂, to create a signal associated with a DNA target that can be measured electiochemically. Fluorescent dyes and Ferrocene are both additives (labels) that unfortunately create background “noise” in the solution that that can interfere with DNA measurement. The application of labeled components in real time PCR has two major drawbacks: (i) insufficient stability of the label itself during thermal cycling process, and (ii) PCR bias associated with amplification error and chain reaction termination due to usage of a ‘foreign’ component. It is very desirable to avoid an application of any labeled components in the PCR process.

It would be advantageous if there was a simpler and more cost-effective way to detect DNA using PCR. It would be advantageous if the DNA measurement could be made without labels that interfere with the DNA signal.

### SUMMARY OF THE INVENTION

In contrast to fluorescent detection, the DNA measurement approach described herein has a high potential for miniaturization and low-cost formats. The principle of action is based on the coupling of a standard thermal cycling PCR process with a transducer capable of quantitative real time label-free detection of DNA products. The transducer is based on an impedance spectroscopy electrode with specific surface functionalization.

Accordingly, an impedance spectroscopy method is provided for quantitatively measuring Deoxyribonucleic acid (DNA). The method provides a transducer having electrode surfaces exposed to a shared local environment. The electrode surfaces are functionalized with an oligonucleotide to interact with a predetermined DNA target. A DNA sample solution is introduced into the local environment. The solution includes nucleotides, polymerase enzyme, and primers. The DNA sample is thermocycled to promote a first DNA target polymerase chain reaction (PCR). Then, capacitance is measured between a pair of transducer electrodes, and in response to measuring the capacitance, a determination is made of the presence of first DNA amplicons in the DNA sample. Typically, a number of thermocycles are performed and capacitance measurements are made after each cycle, so that an amplicon growth rate can be determined.

In one aspect, providing the transducer having electrode surfaces functionalized with the oligonucleotide includes either providing an immobilized probe molecule with a 3′ end attached to the electrodes surfaces and a solution-exposed 5′ end, or an immobilized probes molecule with a 5′ end attached to the electrode surfaces and a solution-exposed 3′ end.

Additional details of the above described method and a system for selectively functionalizing a transducer microarray are provided below.

### BRIEF DESCRIPTION OF THE DRAWINGS

FIG. 1 is a schematic diagram depicting a PCR cycle (prior art).

FIGS. 2A and 2B are plan and partial cross-sectional views, respectively, depicting a microarray of transducers for the impedance spectroscopy quantitative measurement of DNA.

FIG. 3 is a schematic block diagram depicting a variation of the microarray of FIG. 2.

FIGS. 4A and 4B are partial cross-sectional views depicting a transducer electrode surface in greater detail.

FIGS. 5A and 5B are diagrams depicting cycles in a PCR process using a microarray with electrode surfaces functionalized as in FIGS. 4A and 4B, respectively.

FIG. 6 is a graph depicting the relationship between the transducer response and the number of PCR cycles.

FIG. 7 is a flowchart illustrating an impedance spectroscopy method for quantitatively measuring DNA.

FIG. 8 is a graph depicting the impedance spectroscopy detection of a single stranded PCR product.

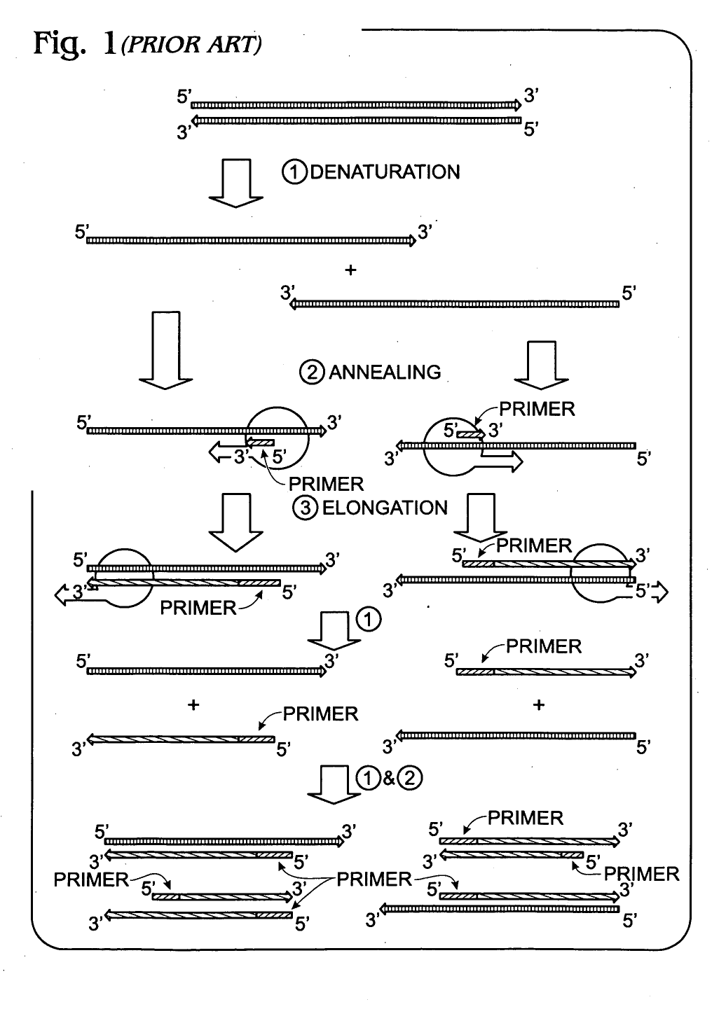

### DETAILED DESCRIPTION

### Transducer and Sensing Element

A transducer is a detector capable of generating a physical signal (output) in response to alterations of biological or chemical environment in the vicinity of the transducer's surface. The signal may be visual or electrical, for example. These alterations occur when a pre-selected biological component that is attached to the transducer's surface specifically interacts with a target analyte, which is the process of bio-recognition. The transducer integrated with the biological component forms a sensing element of a biosensor.

### Biological Components of the Sensing Element: Bio-recognition Components

The biological component responsible for bio-recognition is a molecule capable of specific binding with the target analyte, specific transformation of the corresponding target analyte, or both. An analyte is a substance or chemical constituent that is determined in an analytical procedure, such as a titration. For instance, in an immunoassay, the analyte may be the ligand or the binder, while in blood glucose testing, the analyte is glucose. In medicine, the term “analyte” often refers to the type of test being run on a patient, as the test is usually determining a chemical substance in the human body. An analyte cannot typically be measured, but a measurable property of the analyte can be. For instance, glucose cannot be measured, but glucose concentration can be measured. In this example “glucose” is the component and “concentration” is the property. In laboratory and layman jargon the “property” is often left out provided the omission does not lead to an ambiguity of what property is measured.

Biological components include oligonucleotides, DNA/RNA molecules or their fragments, peptides, receptors, antibodies, enzymes, whole cells and cellular fragments, etc. In some applications biotin and streptavidin can also be considered as biological components.

### Transducer Surface

The transducer surface can be conductive, semi-conductive, or non-conductive. The surface material can be metal or alloy such as gold, platinum, aluminum, chrome, or silica, carbon-based such as graphite or glassy carbon, glass, ceramic, a composite such as silicon nitride or indium tin oxide (ITO), or a plastic such as polystyrene or nylon.

### Transducer Surface Modification

The initial modification of the transducer surface introduces functional groups that are capable of binding other biological components to the sensing element. The introduction of the functional groups to the transducer surface can be performed in one of the following ways:
Direct chemical conversion of the transducer surface. For example, a carbon-based surface can be oxidized using oxygen plasma or an oxidant such as nitric acid.
Surface modification by coating with polymer that contains functional groups in its structure. The polymer coating results in introduction of the groups onto the transducer surface. The polymer can be a biopolymer (poly-sugar, gelatin, etc), polyethyleneimine, polyacrylic acid, hydro-gel (polyvinyl alcohol, silica gel, etc.), nylon, etc.

### Functionalization

Functionalization describes the modification of a transducer surface with attached bio-probe molecules capable of specific biological recognition of analyte molecules. Biological recognition is an ability of the bio-probe molecule to specifically bind or catalytically convert analyte molecules.

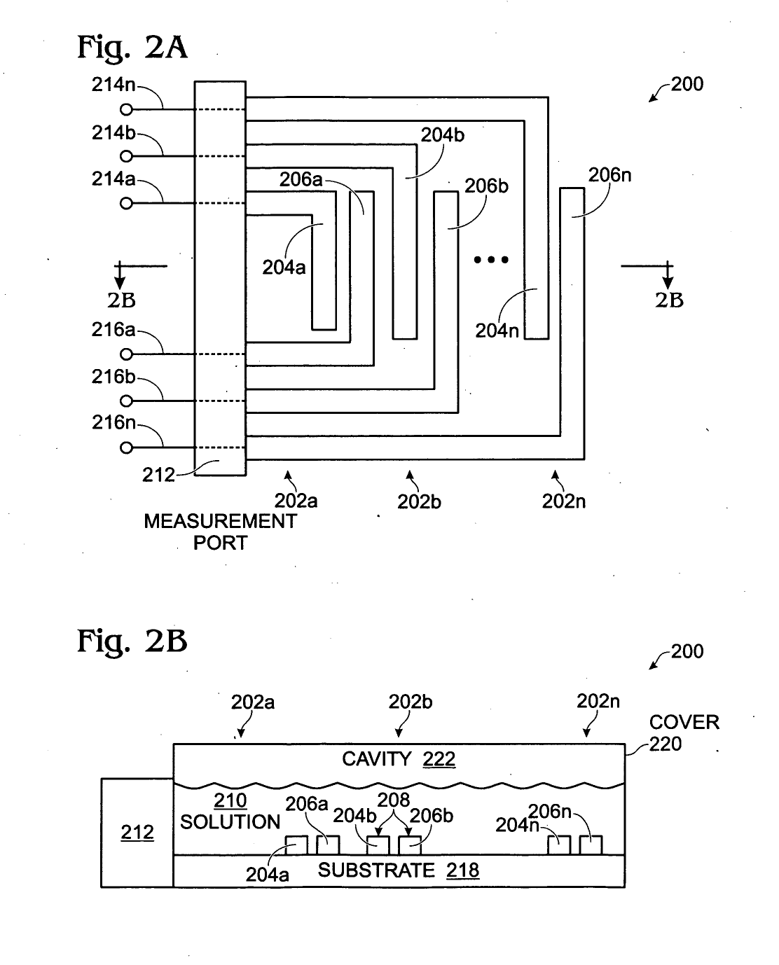

FIGS. 2A and 2B are plan and partial cross-sectional views, respectively, depicting a microarray of transducers for the impedance spectroscopy quantitative measurement of DNA. The microarray 200 comprises a plurality of transducers 202. Shown are transducers 202a, 202b, and 202n. Although n=3 in this example, n is not limited to any particular value. Each transducer 202 has electrodes 204 and 206 with surfaces 208 exposed to a shared DNA sample environment solution 210. As explained in more detail below, the electrode surfaces 208 are functionalized with an oligonucleotide to interact with a predetermined first DNA target. A measurement port 212 has electrical interfaces connected to measure capacitance between the electrodes 204/206 of each transducer 202. As shown, the measurement port 212 includes an independent electrical interface for each electrode. Lines 214a and 216a can be used to measure the capacitance between electrodes 204a and 206a. Lines 214b and 216b can be used to measure the capacitance between electrodes 204b and 206b. Lines 214n and 216n can be used to measure the capacitance between electrodes 204n and 206n.

In one aspect, a substrate 218 underlies the transducers 202 and a cover 220 overlies the transducers. The combination of the substrate 218 and cover 220 forms a cavity 222 to provide the shared DNA sample environment solution 210.

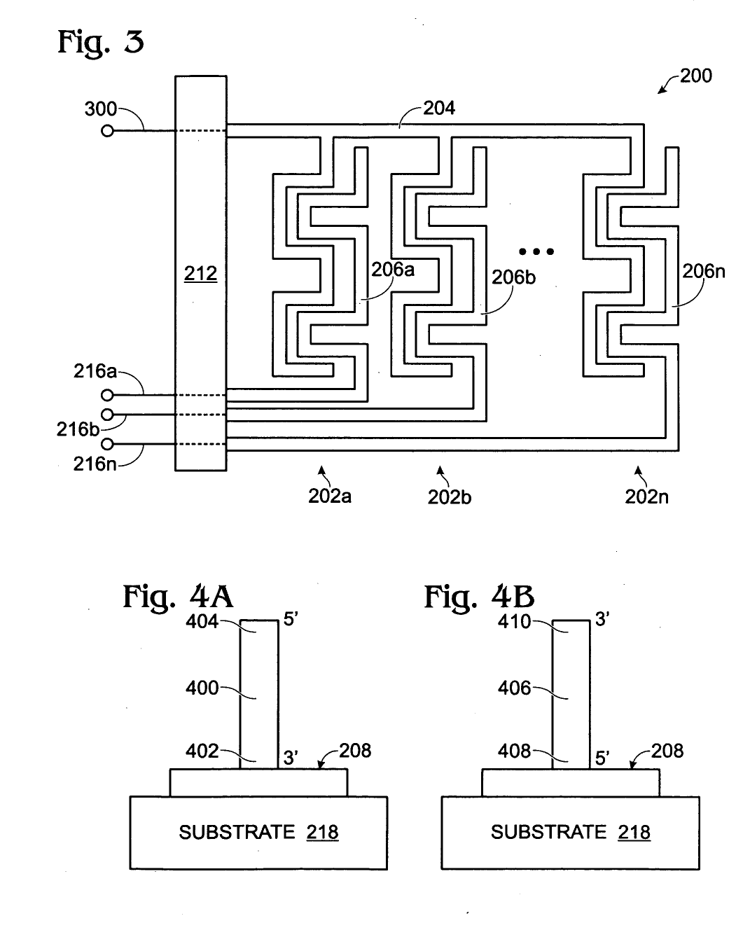

FIG. 3 is a schematic block diagram depicting a variation of the microarray of FIG. 2. In this aspect, the first electrode 204 of each transducer 202 is connected. Therefore, the measurement port 212 has a first electrical interface 300 connected to each first electrode 204, and an independent electrical interface for each second electrode 206a, 206b, and 206n. Lines 300 and 216a can be used to measure the capacitance between electrodes 204 and 206a (transducer 202a). Lines 300 and 216b can be used to measure the capacitance between electrodes 204 and 206b (transducer 202b). Lines 300 and 216n can be used to measure the capacitance between electrodes 204 and 206n (transducer 202n).

In one aspect, as shown in FIG. 3, each transducer 202 includes a first electrode 204 formed in an interdigital pattern with respect to a second electrode 206. However, the microarray is not limited to any particular electrode shape.

FIGS. 4A and 4B are partial cross-sectional views depicting a transducer electrode surface in greater detail. The transducer electrode surface 208 in FIG. 4A is functionalized with an oligonucleotide immobilized probe molecule 400 with a 3′ end 402 attached to the electrodes surface 208 and a solution-exposed 5′ end 404. The immobilized probe molecule 400 is capable of binding to single stranded first DNA amplicons.

In FIG. 4B, the transducer electrode surface 208 is functionalized with an oligonucleotide immobilized probe molecule 406 with a 5′ end 408 attached to the electrode surface 208 and a solution-exposed 3′ end 410. The immobilized probe 406 is capable of binding to single stranded first DNA amplicons, and acting as a primer to enzymatically extend antisense single stranded first DNA amplicons from the immobilized probe molecules.

The PCR thermal cycling process is based on a polymerase extension reaction that involves a target DNA molecule and two specific primers. The process is an exponential amplification, and thus, results in formation of a large amount of copies of the target DNA sequence located between the primers.

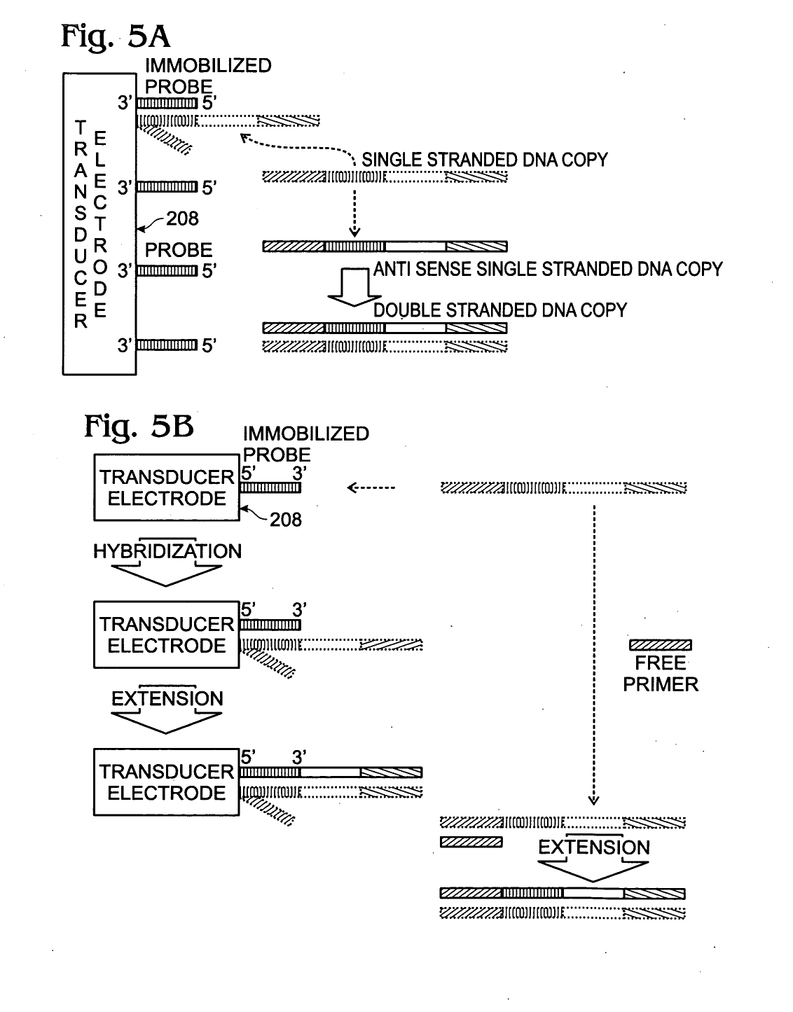

FIGS. 5A and 5B are diagrams depicting cycles in a PCR process using a microarray with electrode surfaces functionalized as in FIGS. 4A and 4B, respectively. In FIG. 5A, the transducer surface 208 is modified with a probe capable of specific hybridization with one of the strands of DNA template. Alternatively (FIG. 5B), the transducer can be modified with one of the primers attached to the surface via its 5′ end. At the denaturing stage of the PCR process, the double-strand DNA molecule denatures forming two single strands. At the annealing stage of PCR process, the single strands compete for binding with the free primers in solution, and the probe on the transducer surface. A fraction of the DNA strands binds to the transducer surface (FIG. 5A), resulting in an increase of the transducer response. When the probe on the transducer surface is a specific primer (FIG. 5B), the target molecule binding to the surface is followed by enzymatic extension of the probe on the surface. This process causes an increase in the size of molecules attached to the transducer surface and leads to a transducer response. In both cases, the attachment of additional molecules to the transducer surface is proportional to the amount of amplified DNA product present in the reaction mixture. Thus, the transducer response permits a real-time quantification of DNA concentration in the sample during PCR cycling.

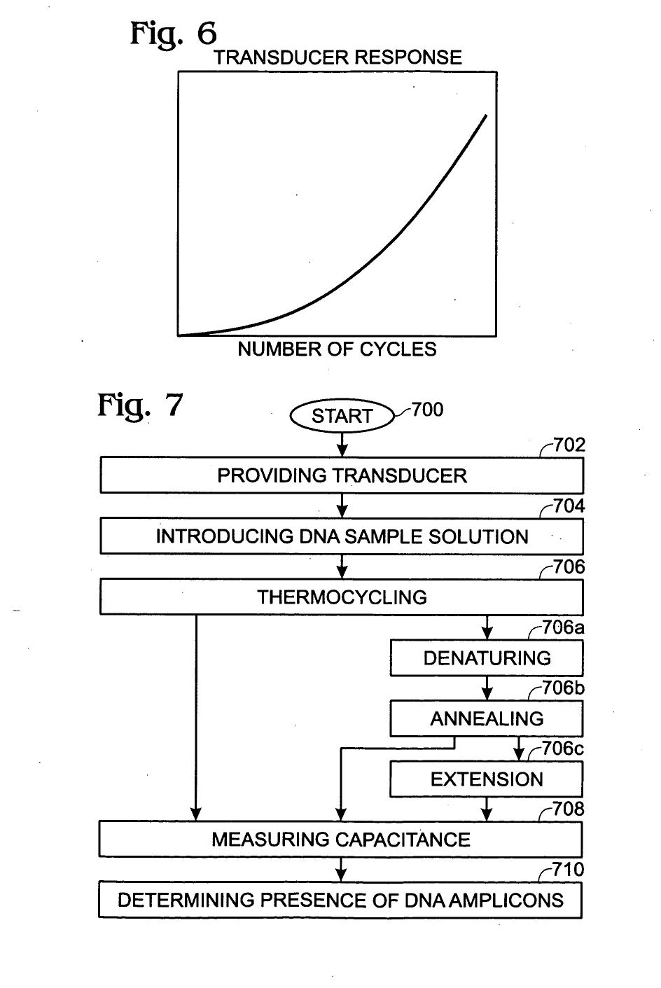

FIG. 6 is a graph depicting the relationship between the transducer response and the number of PCR cycles. The relationship is a function of the initial concentration of DNA template in the sample, and can be used for quantitative determination of the DNA template in a way similar to the conventional fluorescent real time PCR.

FIG. 7 is a flowchart illustrating an impedance spectroscopy method for quantitatively measuring DNA. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 700.

Step 702 provides a transducer having electrode surfaces exposed to a shared local environment. The electrode surfaces are functionalized with an oligonucleotide to interact with a predetermined first DNA target. Step 704 introduces a DNA sample solution, including nucleotides, polymerase enzyme, and primers, into the local environment. Step 706 thermocycles the DNA sample to promote a first DNA target polymerase chain reaction (PCR). Step 708 measures capacitance or impedance between a pair of transducer electrodes. In response to measuring the capacitance, Step 710 determines the presence of first DNA amplicons in the DNA sample. Typically, measuring capacitance between the pair of transducer electrodes in Step 708 includes measuring capacitance in a plurality of thermocycles, and comparing the plurality of capacitance measurements.

In one aspect, providing the transducer having electrode surfaces functionalized with the oligonucleotide in Step 702 includes providing either an oligonucleotide immobilized probe molecule with a 3′ end attached to the electrodes surfaces and a solution-exposed 5′ end (FIG. 4A), or an oligonucleotide immobilized probe molecule with a 5′ end attached to the electrode surfaces and a solution-exposed 3′ end (FIG. 4B). In another aspect, Step 702 provides a first electrode formed in an interdigital pattern with respect to a second electrode.

In a different aspect, thermocycling the DNA sample to promote the first DNA target PCR in Step 706 includes substeps, in each thermocycle. Step 706a denatures the first DNA sample at a first temperature, and Step 706b anneals the first DNA sample at a second temperature, lower than the first temperature. In one variation, Step 706c performs an extension stage, after annealing, at a third temperature in a range between the first and second temperatures.

For example, thermocycling the DNA sample in. Step 706 may include performing 20 to 50 thermocycles. As another example, the denaturing performed in Step 706a may be performed at a temperature of about 95° C., and Step 706b may anneal at a temperature in the range of about 45 to 75° C.

When Step 702 provides electrode surfaces with an oligonucleotide immobilized probe molecule with a 3′ end attached to the electrodes surfaces and a solution-exposed 5′ end, thermocycling the DNA sample in Step 706 includes binding single stranded first DNA amplicons to the immobilized probe molecule in response to each cycle of annealing. Then, measuring capacitance between the pair of transducer electrodes in Step 708 includes measuring capacitance following each cycle of annealing.

When Step 702 provides electrode surfaces with an immobilized probe molecule having a 5′ end attached to the electrode surfaces and a solution-exposed 3′ end, thermocycling the DNA sample includes sustaining a bond between single stranded first DNA amplicons and the immobilized probe molecule following each cycle of denaturing. Then, measuring capacitance in Step 708 includes measuring capacitance following each cycle of denaturing.

Alternately or in addition, thermocycling the DNA sample in Step 706 includes binding single stranded first DNA amplicons to the immobilized probe molecule. The probe acts as a primer to enzymatically extend antisense single stranded first DNA amplicons from the immobilized probe molecules in response to each extension stage. Then, Step 708 may measure capacitance after each stage of extension.

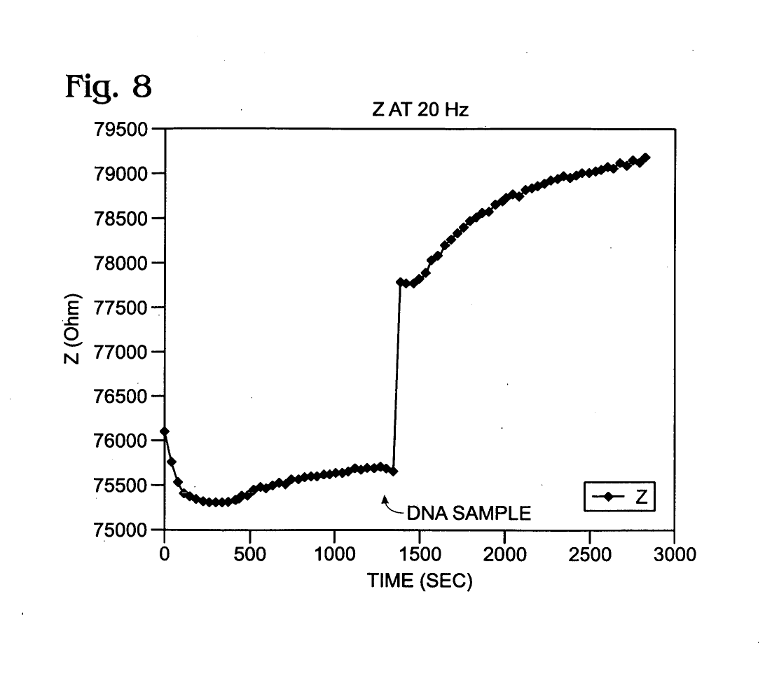

FIG. 8 is a graph depicting the impedance spectroscopy detection of a single stranded PCR product. The measurement was performed to detect a long DNA fragment obtained as a PCR product.

### Experiment:

1. Sample Preparation—A bacterial genome was PCR'ed to form a double stranded DNA as follows:

AATATGGTATTCCGCAAATCTCCACTGGCGATATGCTGCGTGCTGCGGTC
AAATCTGGCTCCGAGCTGGGTAAACAAGCAAAAGACATTATGGATGCTGG
CAAACTGGTCACCGACGAACTGGTGATCGCGCTAAAGAGCGCATTGCTCA
GGAAGACTGCCGCTACGGTTTCCTGTTGGACGGCTTCCCGCGTACCATTC
CGCAGGCAGACGCGATGAAAGAAGCGGGCATCAATGTTGATTACGTTCTG
GAATTCGACGTACCGGACGAACTGATTGTTGACCGTATCGTAGGCCGCCG
CGTTCACGCGCCGTCTGGTCGTGTTTATCACGTTAAATTCAATCCGCCGA
AAGTAGAAGGCAAAGACGACGTTACCGGTGAAGAGCTGACTACCCGTAAA
GACGATCAGGAAGAGACCGTACGTAAACGTCTGGTTGAATACCATCAGAT
GACTGCACCGCTGATCGGCTACTACT-CCAAAGAAGCGGAAGCGGGTAAC
ACCAAATACGCG

The product was then rePCR'ed with a single primer bi-

TTATGGATGCTGGCAAACTG to form a single stranded
DNA:
Biotin-TTATGGATGCTGGCAAACTGGTCACCGACGAACTGGTGATCGC
GCTGGTTAAAGAGCGCATTGCTCAGGAAGACTGCCGCTACGGTTTCCTGT
TGGACGGCTTCCCGCGTACCATTCCGCAGGCAGACGCGATGAAAGAAGCG
GGCATCAATGTTGATTACGTTCTGGAATTCGACGTACCGGACGAACTGAT
TGTTGACCGTATCGTAGGCCGCCGCGTTCACGCGCCGTCTGGTCGTGTTT
ATCACGTTAAATTCAATCCGCCGAAAGTAGAAGGCAAAGACGACGTTACC
GGTGAAGAGCTGACTACCCGTAAAGACGATCAGGAAGAGACCGTACGTAA
ACGTCTGGTTGAATACCATCAGATGACTGCACCGCTGATCGGCTACTAC
T-CCAAAGAAGCGGAAGCGGGTAACACCAAATACGCG

The sample was then diluted in Phosphate Buffer Saline with 0.05% Tween 20 (PBST) (1:50) and used for impedance spectroscopy assay.

2. Thiol modified oligo immobilization on gold

a. a 500 mM solution of DTT was prepared by adding 100 uL of DI water to a Pierce DTT tube.

b. a 50 mM solution of DTT was prepared by adding 10 ul of the 500 mM DTT solution to 90 uL of DI water.

Four uL of 50 mM of Dithiothreitol (DTT) solution in water was added to 100 uL of thiol modified at 5′ end oligonucleotide GATACGGTCAACAATCAGTT solution (10 uM in Phosphate Buffer Saline) and incubated for one hour at ambient temperature. The solution was then applied to a P6 micro-spin column to remove excessive Dithiothreitol. The procedure was repeated with a fresh column. The obtained oligonucleotide solution (6 uL) was then applied to the cleaned gold surface of an interdigitated electrode (see FIG. 3) and incubated at ambient temperature until it dried. The electrode was then washed multiple times with DI water.

3. Impedance Spectroscopy Test

Impedance spectroscopy test was performed at 150 mV. The cell (transducer electrode surface) initially contained PBST alone. After baseline drift was stabilized, PBST was removed from the cell and the sample was added. The results (FIG. 8) show an impedance (Z) dependence on time. The addition of the DNA-containing sample resulted in increase of impedance at a 20 Hz scan frequency. The impedance increase tends to saturate after approximately 1000 seconds. This saturation corresponds to a complete binding of the target DNA to a probe functionalized surface of the interdigitated electrode.

An impedance spectroscopy system and method has been presented for quantitatively measuring DNA. Examples of specific procedures and materials have been used to illustrate the invention. However, the invention is not necessarily limited to just these examples. Other variations and embodiments of the invention will occur to those skilled in the art.

We claim:

1. An impedance spectroscopy method for quantitatively measuring Deoxyribonucleic acid (DNA), the method comprising:
providing a transducer having electrode surfaces exposed to a shared local environment, the electrode surfaces functionalized with an oligonucleotide to interact with a predetermined first DNA target;
introducing a DNA sample solution, including nucleotides, polymerase enzyme, and primers, into the local environment;
thermocycling the DNA sample to promote a first DNA target polymerase chain reaction (PCR);
measuring capacitance between a pair of transducer electrodes: and,
in response to measuring the capacitance, determining a presence of first DNA amplicons in the DNA sample.

2. The method of claim 1 wherein providing the transducer having electrode surfaces functionalized with the oligonucleotide includes providing electrode surfaces with an olignucleotide selected from a group consisting of:
an immobilized probe molecule with a 3′ end attached to the electrodes surfaces and a solution-exposed 5′ end; and,
an immobilized probe molecule with a 5′ end attached to the electrode surfaces and a solution-exposed 3′ end.

3. The method of claim 1 wherein providing the transducer having electrode surfaces functionalized with the oligonucleotide includes providing a first electrode formed in an interdigital pattern with respect to a second electrode.

4. The method of claim 1 wherein thermocycling the DNA sample to promote the first DNA target PCR includes, in each thermocycle:
denaturing the first DNA sample at a first temperature; and,
annealing the first DNA sample at a second temperature, lower than the first temperature.

5. The method of claim 4 wherein each thermocycle further includes an extension stage performed, after annealing, at a third temperature in a range between the first and second temperatures.

6. The method of claim 4 wherein thermocycling the DNA sample to promote the first DNA target PCR includes performing 20 to 50 thermocycles.

7. The method of claim 4 wherein thermocycling the DNA sample to promote the first DNA target PCR includes denaturing at a temperature of about 95° C., and annealing at a temperature in a range of about 45 to 75° C.

8. The method of claim 4 wherein providing the transducer having electrode surfaces functionalized with the oligonucleotide includes providing electrode surfaces with an olignucleotide immobilized probe molecule with a 3′ end attached to the electrodes surfaces and a solution-exposed 5′ end;
wherein thermocycling the DNA sample includes binding single stranded first DNA amplicons to the immobilized probe molecule in response to each cycle of annealing; and,
wherein measuring capacitance between the pair of transducer electrodes includes measuring capacitance following each cycle of annealing.

9. The method of claim 1 wherein measuring capacitance between the pair of transducer electrodes includes:
measuring capacitance in a plurality of thermocycles; and,
comparing the plurality of capacitance measurements.

10. The method of claim 4 wherein providing the transducer having electrode surfaces functionalized with the oligonucleotide includes providing electrode surfaces with an immobilized probe molecule having a 5′ end attached to the electrode surfaces and a solution-exposed 3′ end;
wherein thermocycling the DNA sample includes sustaining a bond between single stranded first DNA amplicons and the immobilized probe molecule, following each cycle of denaturing;
wherein measuring capacitance between the pair of transducer electrodes includes measuring capacitance following each cycle of denaturing.

11. The method of claim 5 wherein providing the transducer having electrode surfaces functionalized with the oligonucleotide includes providing electrode surfaces with an immobilized probe molecule having a 5′ end attached to the electrode surfaces and a solution-exposed 3′ end;
wherein thermocycling the DNA sample includes binding single stranded first DNA amplicons to the immobilized probe molecule, the probe acting as a primer to enzynmatically extend antisense single stranded first DNA amplicons from the immobilized probe molecules in response to each extension stage;
wherein measuring capacitance between the pair of transducer electrodes includes measuring capacitance after each stage of extension.

12-19. (canceled)
